(19) United States
(12) Patent Application Publication
(10) Pub. No.: US 2014/0231103 A1
(43) Pub. Date: Aug. 21, 2014

(54) Identification Sleeve for Flexible Conduit

(71) Applicant: Victaulic Company, Easton, PA (US)

(72) Inventors: Thomas C. Savage, Doylestown, PA (US); Lawrence W. Thau, JR., Flemington, NJ (US)

(21) Appl. No.: 14/178,915

(22) Filed: Feb. 12, 2014

Related U.S. Application Data
(60) Provisional application No. 61/765,233, filed on Feb. 15, 2013.

(51) Int. Cl. A62C 35/68

(52) U.S. Cl. CPC A62C 35/68
USPC 169/16; 138/118; 29/428

(57) ABSTRACT

A sprinkler assembly has a sleeve covering at least a portion of a conduit connecting the sprinkler to a branch line of a fire suppression system. The sleeve may have a color field, contrasting color patterns, symbols, indicia, or combinations of these elements and may be used to visibly indicate characteristics of the sprinkler assembly.

### CROSS REFERENCE TO RELATED APPLICATION

This application is based upon and claims priority to U.S. Provisional Application No. 61/765,233, filed Feb. 15, 2013, and hereby incorporated by reference.

### FIELD OF THE INVENTION

This invention relates to a sleeve positionable on a flexible conduit assembly for connecting sprinklers to branch lines in a fire suppression system, the sleeve serving to identify characteristics of the flexible conduit assembly.

### BACKGROUND

Fire suppression sprinkler systems used, for example, in structures such as office buildings, hotels, warehouses and private residences have a piping network comprising a riser pipe connected to a source of pressurized fire suppressing fluid, for example, a liquid, such as water, or a gas, such as halon. Branch pipe lines are connected to the riser pipe at each floor of the structure and extend throughout each floor so that fire suppressing fluid may be delivered through the branch lines to any location on each floor. The branch lines are usually suspended on hangers attached to the structural ceiling of each floor. Sprinklers, which serve to discharge the fluid in the event of a fire, are connected to the branch lines by flexible conduits. The use of flexible conduits provides a great advantage as it allows the position of the sprinklers to be easily adjusted, both laterally and vertically, in relation to the decorative ceiling which may be suspended beneath the structural ceiling of each floor. The flexible conduit saves time during installation, as it obviates the need for the technician to install a rigid pipe assembly, comprised of threaded pipe elements and threaded fittings, to connect the branch line to each sprinkler head on the floor. With a rigid pipe assembly even a minor miscalculation, either in the design or installation, can be aesthetically and functionally unacceptable, and require a redesign and reinstallation.

As with many other fire safety related components, flexible conduits and the assemblies in which they are used must be approved into various categories by different agencies such as Underwriters' Laboratories (UL), the National Fire Protection Association (NFPA) and Factory Mutual (FM). Installations using approved components must be inspected and must pass inspection before they are given the stamp of approval which states that they meet the appropriate requirements.

Inspection of fire suppression sprinkler systems poses various practical problems due to the general inaccessibility of the sprinklers and their connecting conduits because they are often mounted high among ceiling structures, such as rafters or truss work, or above storage racks in warehouses high above the floor. In addition to the inaccessibility of the assemblies, inspection is further complicated by the fact that, from a distance, approved assemblies can be confused with non-approved assemblies or assemblies approved in other categories. A visual inspection of each sprinkler assembly therefore requires that an inspector mount a ladder, scaffolding, or a lift to view each assembly in detail to ensure that approved components which meet the requirements have been used. There is clearly a need for an identification device which makes inspection of sprinkler conduit assemblies easier to accomplish.

### SUMMARY

In one example embodiment, the invention encompasses, in combination, a flexible conduit and a sleeve covering at least a portion of the flexible conduit. The sleeve comprises a sidewall surrounding a central space. The central space receives the conduit. The sleeve is movable axially along the conduit and positionable at one of a plurality of positions between a first and a second end of the conduit. In a particular example, the sidewall is a unitary construction having no seam. In another example, the sidewall may have an inner surface, at least a portion of which contacts an outer surface of the conduit. Friction between the inner and outer surfaces holds the sleeve in the one of the plurality of positions along the conduit.

In another example embodiment, the sidewall has an outer surface, and the outer surface of the sidewall has a contrasting color from the conduit. In another example embodiment, the sidewall has an outer surface, and the outer surface of the sidewall has a plurality of contrasting stripes thereon.

By way of example, the sidewall may be flexible and will deform to accommodate the shape of the conduit.

In another example embodiment, the conduit comprises a braided outer layer. In another example embodiment, the conduit comprises a corrugated outer layer.

By way of example, the invention may also encompass a sprinkler assembly for use with a piping network of a fire suppression system. In an example embodiment, the sprinkler assembly comprises a sprinkler. A flexible conduit has a first end connected in fluid communication with the sprinkler. A second end of the flexible conduit is connectable in fluid communication with the piping network of the fire suppression system. A sleeve covers a portion of the flexible conduit. The sleeve comprises a sidewall surrounding a central space which receives the conduit. In one example embodiment, the sleeve is movable axially along the conduit and is positionable at one of a plurality of positions between the first and second ends of the conduit. In another example, the sleeve is fixed at one of a plurality of positions between the first and second ends of the conduit.

In a particular example embodiment, the sidewall is a unitary construction having no seam. In another example embodiment, the sidewall has an inner surface which contacts an outer surface of the conduit. Friction between the inner and outer surfaces holds the sleeve in the one of the plurality of positions along the conduit.

In another example embodiment, the sidewall has an outer surface, the outer surface of the sidewall having a contrasting color from the conduit. In another example embodiment, the sidewall has an outer surface, the outer surface of the sidewall having a plurality of contrasting stripes thereon.

In a particular example embodiment, the sidewall is flexible and will deform to accommodate the shape of the conduit.

In one example embodiment, the conduit comprises a braided outer layer. In another example embodiment, the conduit comprises a corrugated outer layer.

The invention further encompasses a method of installing a sprinkler assembly in a piping network. In one example method, the sprinkler assembly has a sprinkler attached to a flexible conduit. A sleeve surrounds a portion of the conduit. The method comprises:
attaching one end of the flexible conduit in fluid communication with the piping network;
fixing the sprinkler in a desired position; and
moving the sleeve along the conduit to a position wherein the sleeve is readily visible.

The invention also contemplates a method of identifying a sprinkler assembly. In an example method, the sprinkler assembly has a sprinkler attached to a flexible conduit. The example method comprises surrounding a portion of the flexible conduit with a sleeve, the sleeve having visible markings thereon corresponding to at least one of a plurality of characteristics of the sprinkler assembly. The markings may comprise color fields, such as orange, yellow or other highly visible hues. By way of further example, the markings may comprise patterns of contrasting color. The markings may also comprise indicia.

The characteristics identified by the sleeve can include (but are not limited to) the manufacturer of the assembly, the length of the conduit, the diameter of the conduit, the sprinkler K factor, the particular agency listing, the particular agency category listing, and combinations thereof.

### BRIEF DESCRIPTION OF THE DRAWINGS

FIG. 1 is an isometric view of an example sprinkler assembly embodiment according to the invention;

FIG. 2 is a side view of an example combination of a flexible conduit and sleeve according to the invention;

FIG. 3 is an isometric view of an example sleeve embodiment according to the invention; and

FIG. 4 is an isometric view of an example sleeve embodiment according to the invention.

### DETAILED DESCRIPTION

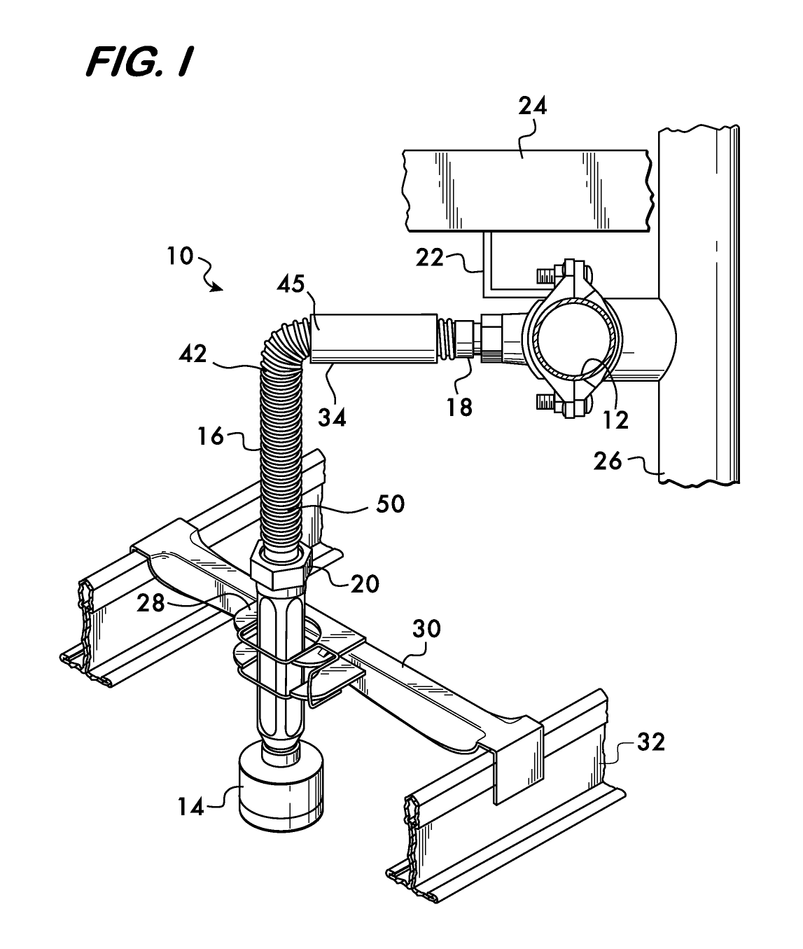

FIG. 1 shows an assembly 10 for connecting a branch line 12 of a fire suppression system to a sprinkler 14. Note that sprinkler is defined herein as any device which discharges a fire suppression fluid, and includes, but is not limited to, items such as sprinklers, heads, nozzles, emitters and the like, whether they be open or closed and open in response to a fire. Assembly 10 comprises a flexible conduit 16 which has a first end 18 connected to the branch line 12, and a second end 20 which is connected to the sprinkler 14. The branch line 12 is supported by a pipe hanger 22 attached to a portion of the structure in which the fire suppression system is mounted, in this example, to the structural ceiling 24 of a building. Branch line 12 is one of many branch lines connected to a riser pipe 26 in fluid communication with a pressurized source of a fire suppressing fluid, such as water (not shown). A portion of the assembly 10 near the second end 20 of the flexible conduit 16 is engaged by a bracket 28 that is mounted on a cross beam 30 which extends between and is mounted on support rails 32 which support a decorative ceiling, such as a suspended ceiling or a drop ceiling (not shown) intended to hide the structural ceiling 24. Other mounting configurations are also feasible, the configuration shown in FIG. 1 being by way of example only.

As shown in FIG. 1, a sleeve 34 covers a portion of the flexible conduit 16. Sleeve 34 is positioned on conduit 16 between first and second ends 18 and 20. In this example sleeve 34 is positioned near first end 18, where it may be highly visible to an inspector looking up from the ground beneath the installation. However, the sleeve 34 is slidably movable along the conduit 16 so that it may be positioned at any one of a plurality of positions between the first and second ends where it will be most easily seen.

As shown in detail in FIG. 3, sleeve 34 comprises a sidewall 36 that surrounds a central space 38. Central space 38 receives the flexible conduit 16. Sidewall 36 in this example is of unitary construction, meaning it has no seam. Sidewalls having seams however are also feasible. Sidewall 36 has an inner surface 40 which contacts the outer surface 42 of the conduit 16 (see FIG. 1). Friction between the inner surface 40 of sidewall 36 and the outer surface 42 of the conduit 16 may be used to hold the sleeve 34 in the desired position once that position has been determined.

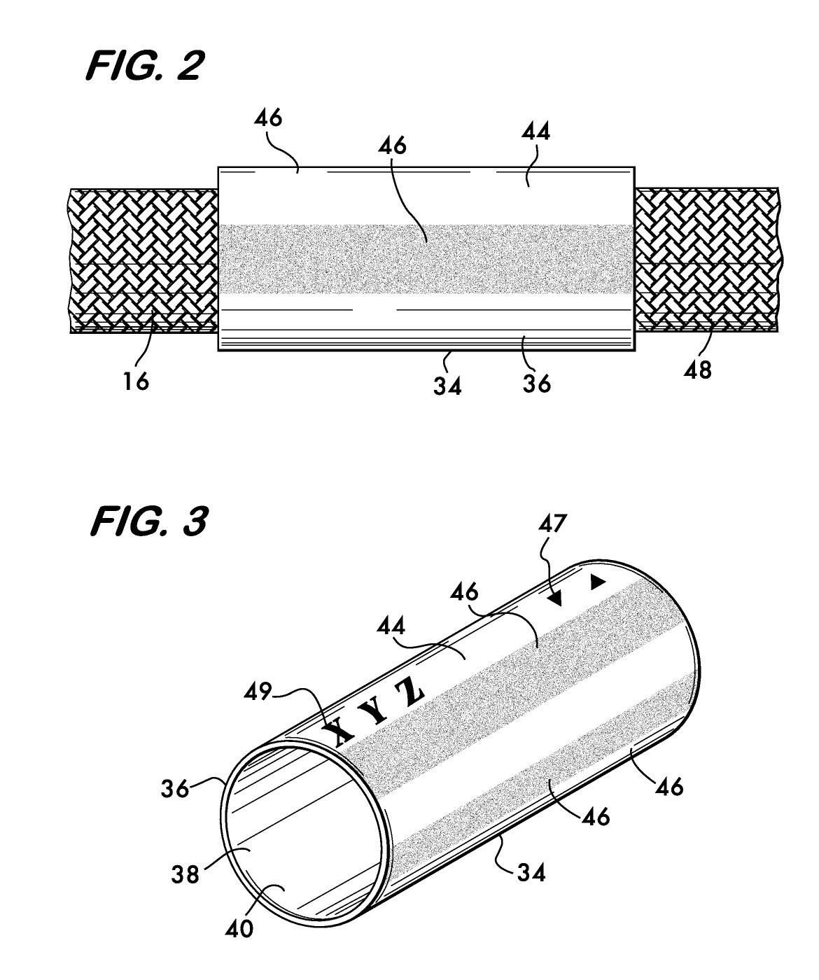

Sidewall 36 of sleeve 34 also has an outer surface 44. Outer surface 44 will be visible for inspection of the sprinkler assembly 10, and therefore it is advantageous to enhance its visibility. This may be done, for example, by having an outer surface 44 with a contrasting color from the conduit 16 (a “color field” 45, shown in FIG. 1). Highly visible colors, such as orange, are effective at enhancing the visibility. In addition to or instead of a color field, markings comprising patterns of contrasting color may be used. An example of such an embodiment is shown in FIGS. 2 and 3, where longitudinal stripes 46 of contrasting colors are found on the outer surface 44 of the sidewall 36 of the sleeve 34. Additionally, it is further advantageous to provide symbols 47 or indicia 49 on the outer surface 44 as shown in FIG. 3.

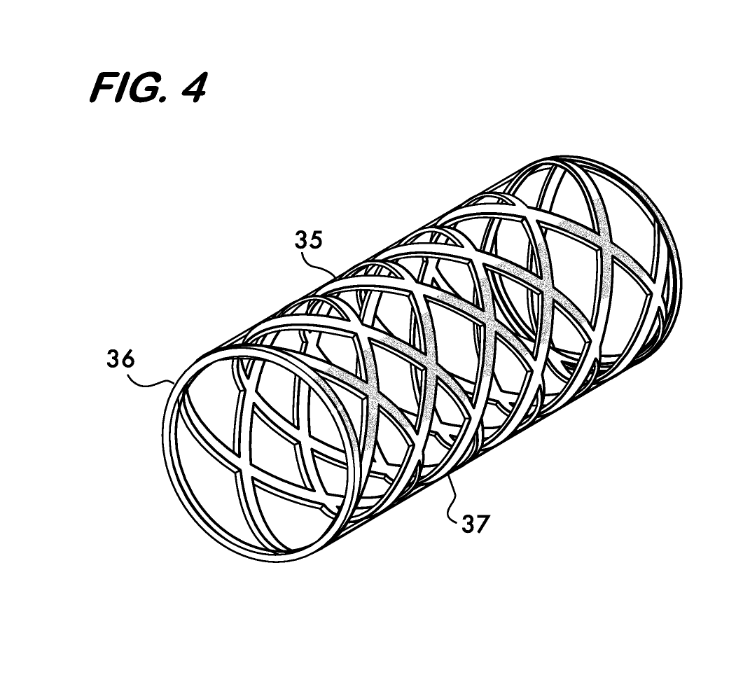

FIG. 4 illustrates a sleeve embodiment 35 wherein sidewall 36 comprises an open mesh 37. Mesh 37 may be woven, knitted, or braided for example, or may be extruded, continuously formed, or formed by perforating an otherwise solid sidewall.

It is also advantageous that the sidewall 36 of sleeves 34 or 35 be flexible so as to deform and accommodate the shape of the conduit 16. This flexibility will facilitate moving and positioning of the sleeve 34 along a curved conduit as well as permit the conduit 16 to deform relatively unhindered. To this end, the sleeves 34 and 35 may be made of flexible, resilient materials such as nylon, polyethylene as well as other polymer compounds.

FIG. 2 illustrates a combination flexible conduit 16 and sleeve 34. Sleeve 34 surrounds a portion of the conduit between its first and second ends (only one end being shown). In the example shown in FIG. 2, the flexible conduit 16 has a braided outer layer 48 formed of stainless steel wire. Other materials are of course feasible. The example embodiment of the conduit 16 shown in FIG. 1 has a corrugated outer layer 50. Other types of construction for the flexible conduit 16 are also feasible. Furthermore, it is understood that sleeve 35, comprising an open mesh (see FIG. 4), could also be used in combination with the conduit 16.

Sleeves 34 or 35 according to the invention used in combination with flexible conduits 16, for example, in fire suppression systems, permit the characteristics of the assembly or combination to be readily visually identified from a distance. This property of ready visual identification along with the ability to position the sleeve at a visible portion of the conduit greatly simplifies the work of inspectors, obviating the need for ladders, lifts and scaffolding. The sleeve may be used to indicate any of a number of characteristics of the assembly or combination, including, without limitation, the manufacturer, the length of the conduit, the diameter of the conduit, the type of sprinkler required for the conduit, the particular agency listing, the particular agency category listing, as well as other information.

What is claimed is:

1. In combination, a flexible conduit and a sleeve covering at least a portion of said flexible conduit, said sleeve comprising a sidewall surrounding a central space receiving said conduit, said sleeve being movable axially along said conduit and positionable at one of a plurality of positions between a first and a second end of said conduit.

2. The combination according to claim 1, wherein said sidewall is a unitary construction having no seam.

3. The combination according to claim 1, wherein said sidewall comprises an open mesh.

4. The combination according to claim 1, wherein said sidewall has an inner surface, at least a portion of said inner surface contacting an outer surface of said conduit.

5. The combination according to claim 4, wherein friction between said inner and outer surfaces holds said sleeve in said one of said plurality of positions along said conduit.

6. The combination according to claim 1, wherein said sidewall has an outer surface, said outer surface of said sidewall having a contrasting color from said conduit.

7. The combination according to claim 1, wherein said sidewall has an outer surface, said outer surface of said sidewall having a plurality of contrasting stripes thereon.

8. The combination according to claim 1, wherein said sidewall is flexible and will deform to accommodate the shape of said conduit.

9. The combination according to claim 1, wherein said conduit comprises a braided outer layer.

10. The combination according to claim 1, wherein said conduit comprises a corrugated outer layer.

11. A sprinkler assembly for use with a piping network of a fire suppression system, said sprinkler assembly comprising:
a sprinkler;
a flexible conduit having a first end connectable in fluid communication with said piping network of said fire suppression system and a second end connected in fluid communication with said sprinkler;
a sleeve covering at least a portion of said flexible conduit, said sleeve comprising a sidewall surrounding a central space receiving said conduit.

12. The sprinkler assembly according to claim 11, wherein said sleeve is movable axially along said conduit and positionable at one of a plurality of positions between said first and second ends of said conduit.

13. The sprinkler assembly according to claim 11, wherein said sleeve is fixed at one of a plurality of positions between said first and second ends of said conduit.

14. The sprinkler assembly according to claim 11, wherein said sidewall is a unitary construction having no seam.

15. The sprinkler assembly according to claim 11, wherein said sidewall is an open mesh.

16. The sprinkler assembly according to claim 11, wherein said sidewall has an inner surface, at least a portion of said inner surface contacting an outer surface of said conduit.

17. The sprinkler assembly according to claim 16, wherein friction between said inner and outer surfaces holds said sleeve in said one of said plurality of positions along said conduit.

18. The sprinkler assembly according to claim 11, wherein said sidewall has an outer surface, said outer surface of said sidewall having a contrasting color from said conduit.

19. The sprinkler assembly according to claim 11, wherein said sidewall has an outer surface, said outer surface of said sidewall having a plurality of contrasting stripes thereon.

20. The sprinkler assembly according to claim 11, wherein said sidewall is flexible and will deform to accommodate the shape of said conduit.

21. The sprinkler assembly according to claim 11, wherein said conduit comprises a braided outer layer.

22. The sprinkler assembly according to claim 11, wherein said conduit comprises a corrugated outer layer.

23. A method of installing a sprinkler assembly in a piping network, the sprinkler assembly having a sprinkler attached to a flexible conduit, and a sleeve surrounding a portion of said conduit, the method comprising:
attaching one end of said flexible conduit in fluid communication with said piping network;
fixing said sprinkler in a desired position; and
moving said sleeve along said conduit to a position wherein said sleeve is readily visible.

24. A method of identifying a sprinkler assembly, the sprinkler assembly having a sprinkler attached to a flexible conduit, the method comprising surrounding a portion of said flexible conduit with a sleeve, said sleeve having visible markings thereon corresponding to at least one of a plurality of characteristics of said sprinkler assembly.

25. The method according to claim 24, wherein said markings comprise color fields.

26. The method according to claim 24, wherein said markings comprise patterns of contrasting color.

27. The method according to claim 24, wherein said markings comprise indicia.

28. The method according to claim 24, wherein said markings comprise symbols.

29. The method according to claim 24, wherein said characteristics are selected from the group consisting essentially of a manufacturer of the assembly, a length of the conduit, a diameter of the conduit, a sprinkler K factor, a particular agency listing, a particular agency category listing, and combinations thereof.
